(19) United States
(12) Patent Application Publication
(10) Pub. No.: US 2015/0046203 A1
(43) Pub. Date: Feb. 12, 2015

(54) Determining Recommendations In Data Analysis

(71) Applicant: International Business Machines Corporation, Armonk, NY (US)

(72) Inventors: Parag S. Gokhale, Pune (IN); Robin N. Grosset, Ottawa (CA); Rajanikant Malviya, Pune (IN); Amit Mittal, Pune (IN)

(73) Assignee: International Business Machines Corporation, Armonk, NY (US)

(21) Appl. No.: 13/959,883

(22) Filed: Aug. 6, 2013

(51) Int. Cl. G06Q 10/06

(52) U.S. Cl. CPC G06Q 10/063
USPC 705/7.11

(57) ABSTRACT

Embodiments of the present invention disclose a method, computer program product, and system for determining recommendations in data analysis. A computer identifies an analysis step currently being performed in a data analysis. The computer identifies data points corresponding to the identified analysis step currently being performed and one or more previous analyses. The computer determines a distance between the data points corresponding to the identified analysis step currently being performed and each of the one or more previous data analyses utilizing a distance computing algorithm. The computer determines a ranking of the one or more previous data analyses corresponding to the determined distances between the data points corresponding to the identified analysis step currently being performed and each of the one or more previous data analyses.

### FIELD OF THE INVENTION

The present invention relates generally to the field of data analysis, and more particularly to determining recommendations in data analysis.

### BACKGROUND OF THE INVENTION

With increasing amounts of available data, data analysis is increasingly important for determining relevant information from a large volume of data. Business analytics makes use of data analysis in an effort to determine important information (e.g., trends) from large volumes of data. Data can be utilized with business analytics for statistical and quantitative analysis, visualization, predictive modeling and other forms of data analysis in accordance with goals of a business.

Business analytics utilizes data from a variety of different domains to derive a visualization that encompasses multiple aspects of the business. For example, data analysis in business analytics can be used to visualize a graphical depiction of sales of different types of products relative to the method with which an order was placed (e.g., online, telephone, in-store). Determining relevant trends in an analysis of data is a multi-step and multi-variable process, which can be accomplished through a variety of different methods. An individual experienced in the business analytics field is more likely to be familiar with methods that can produce insights that correspond to the interests of a business.

### SUMMARY

Embodiments of the present invention disclose a method, computer program product, and system for determining recommendations in data analysis. A computer identifies an analysis step currently being performed in a data analysis. The computer identifies data points corresponding to the identified analysis step currently being performed and one or more previous analyses. The computer determines a distance between the data points corresponding to the identified analysis step currently being performed and each of the one or more previous data analyses utilizing a distance computing algorithm. The computer determines a ranking of the one or more previous data analyses corresponding to the determined distances between the data points corresponding to the identified analysis step currently being performed and each of the one or more previous data analyses. In another embodiment, the computer determines recommendations in the data analysis utilizing the determined ranking of the one or more previous data analyses, wherein the recommendations include possible next analytical steps that correspond to the one or more previous data analyses.

### BRIEF DESCRIPTION OF THE SEVERAL VIEWS OF THE DRAWINGS

FIG. 1 is a functional block diagram of a data processing environment in accordance with an embodiment of the present invention.

FIG. 2 is a flowchart depicting operational steps of a program for determining recommendations in a data analysis, in accordance with an embodiment of the present invention.

FIG. 3 is an exemplary depiction of a table including previous data analyses, in accordance with an embodiment of the present invention.

FIG. 4 depicts a block diagram of components of the computing system of FIG. 1 in accordance with an embodiment of the present invention.

### DETAILED DESCRIPTION

Exemplary embodiments of the present invention allow for providing recommendations of analytical steps to an individual performing an analysis of data. In one embodiment, a current data analysis step is compared to previous analyses in order to identify previous analyses that are similar to the current data analysis step. In previous analyses that are similar to the current data analysis step, next analytical steps are recommended to the individual performing the data analysis, wherein the recommendations correspond to criteria that the individual may specify.

Embodiments of the present invention recognize that as the volume of data increases, data analysis becomes more difficult. For less experienced individuals analyzing a large volume of data, simply presenting a visualization of retrieved data may not provide enough information to determine trends and other information from the data. Providing recommendations of analysis steps to an individual analyzing data can increase the likelihood of determining relevant insights into the data. Individuals analyzing data often start by analyzing data at a high level, and systematically narrow the scope of the analysis through filtering until the desired level of analysis is achieved.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java®, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

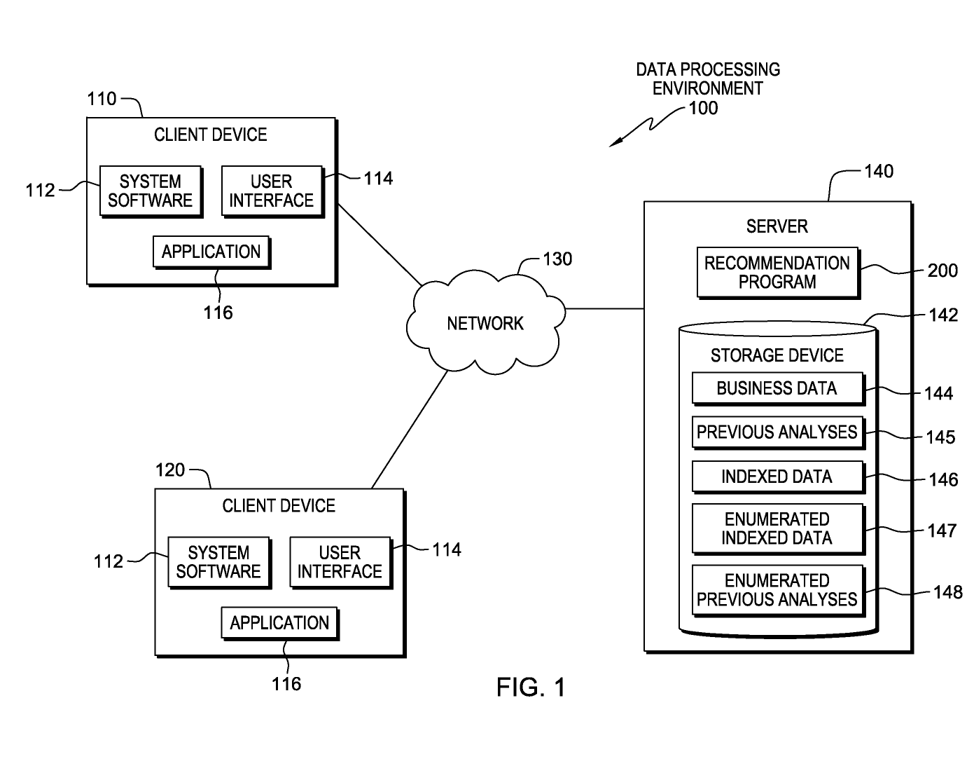

The present invention will now be described in detail with reference to the Figures. FIG. 1 is a functional block diagram illustrating data processing environment 100, in accordance with one embodiment of the present invention.

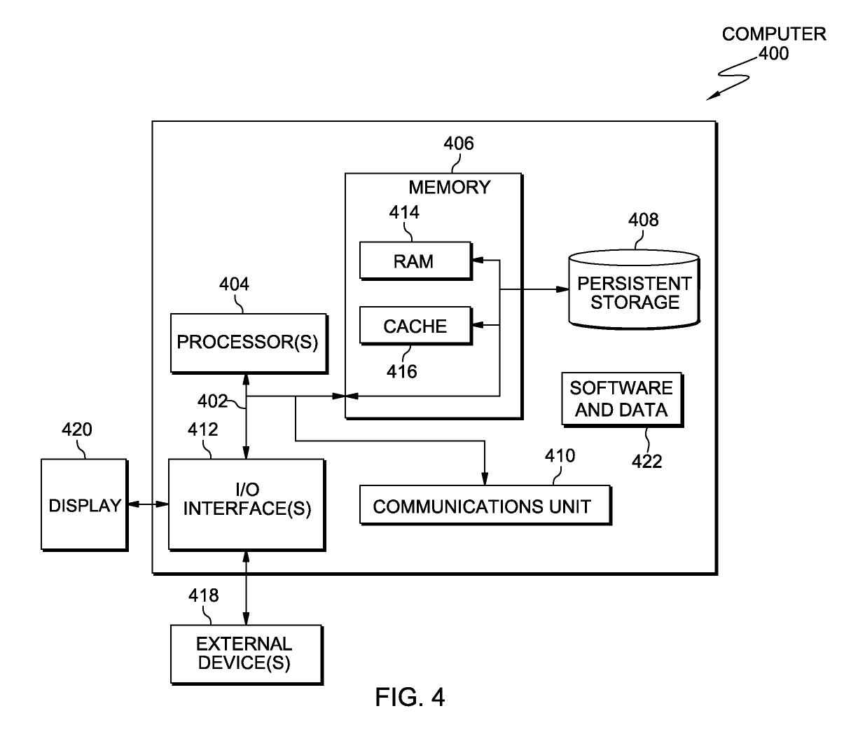

An exemplary embodiment of data processing environment 100 includes client devices 110 and 120, and server 140, all interconnected over network 130. In various embodiments of the present invention, client devices 110 and 120 may be workstations, personal computers, personal digital assistants, mobile phones, or any other devices capable of executing program instructions in accordance with embodiments of the present invention. In general, client devices 110 and 120 are representative of any electronic device or combination of electronic devices capable of executing machine-readable program instructions, as described in greater detail with regard to FIG. 4, in accordance with embodiments of the present invention. Client devices 110 and 120 can access data on server 140 through network 130.

Client devices 110 and 120 include respective instances of system software 112, user interface 114, and application 116. In one embodiment, system software 112 may exist in the form of operating system software, which may include Windows®, LINUX®, and other application software such as internet applications and web browsers. User interface 114 accepts input from individuals utilizing client devices 110 and 120. In exemplary embodiments, application 116 on client devices 110 and 120 analyze data stored on server 140. For example, application 116 accesses data on server 140 corresponding to sales of different types of products, and creates a visualization (e.g., table, graphical depiction, etc.) of the sales of different types of products relative to the method with which an order was placed (e.g., online, telephone, in-store). In exemplary embodiments, application 116 receives input from user interface 114, which may be provided by an individual utilizing client devices 110 and 120.

In one embodiment, client devices 110 and 120, and server 140 communicate through network 130. Network 130 can be, for example, a local area network (LAN), a telecommunications network, a wide area network (WAN) such as the Internet, or a combination of the three, and include wired, wireless, or fiber optic connections. In general, network 130 can be any combination of connections and protocols that will support communications between client devices 110 and 120, and server 140 in accordance with exemplary embodiments of the present invention.

In exemplary embodiments, server 140 can be a desktop computer, computer server, or any other computer system known in the art. In certain embodiments, server 140 represents computer systems utilizing clustered computers and components (e.g., database server computers, application server computers, etc.) that act as a single pool of seamless resources when accessed by elements of data processing environment 100 (e.g., client devices 110 and 120). In general, server 140 is representative of any electronic device or combination of electronic devices capable of executing machine-readable program instructions, as described in greater detail with regard to FIG. 4, in accordance with embodiments of the present invention.

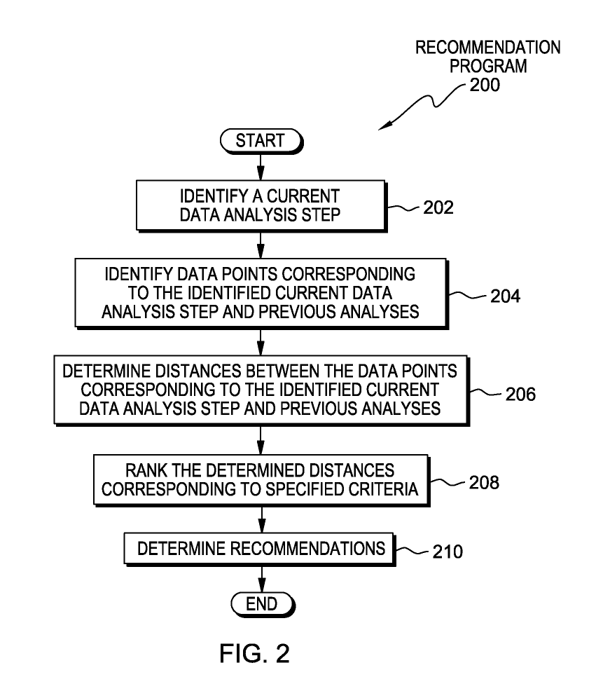

Server 140 includes storage device 142, and recommendation program 200. Storage device 142 can be implemented with any type of storage device that is capable of storing data that may be accessed and utilized by client devices 110 and 120, and server 140 such as a database server, a hard disk drive, or flash memory. In other embodiments, storage device 142 can represent multiple storage devices within server 140. In exemplary embodiments, recommendation program 200 provides recommendations in a data analysis corresponding to a current data analysis step. Recommendation program 200 is discussed in greater detail with regard to FIG. 2.

In one embodiment, storage device 142 includes business data 144, previous analyses 145, indexed data 146, enumerated indexed data 147, and enumerated previous analyses 148. In another embodiment, business data 144, previous analyses 145, indexed data 146, enumerated indexed data 147, and enumerated previous analyses 148 can be located in separate storage devices or servers (e.g., distributed in a cloud computing deployment within data processing environment 100), which can be accessed through network 130 in data processing environment 100. Business data 144 includes any type of data that application 116 can access and analyze (e.g., sales data, financial data, resource utilization, and other forms of data associated with business analytics). For example, business data 144 includes sales data of different types of products, wherein the sales data includes an amount of each product sold, price of each sale, method with which an order was placed (e.g., online, telephone, in-store), time sold, and other data corresponding to the sale of products.

Previous analyses 145 includes data from previous analyses of business data 144. For example, business data 144 may have been analyzed multiple times by application 116, utilizing differing analysis paths to analyze different sets of data. In an exemplary embodiment, previous analyses 145 includes previous visualizations determined from business data 144, and the data that is associated with the visualizations. Previous analyses 145 includes data necessary to recreate analysis states (i.e. steps in data analyses) that have been previously reached.

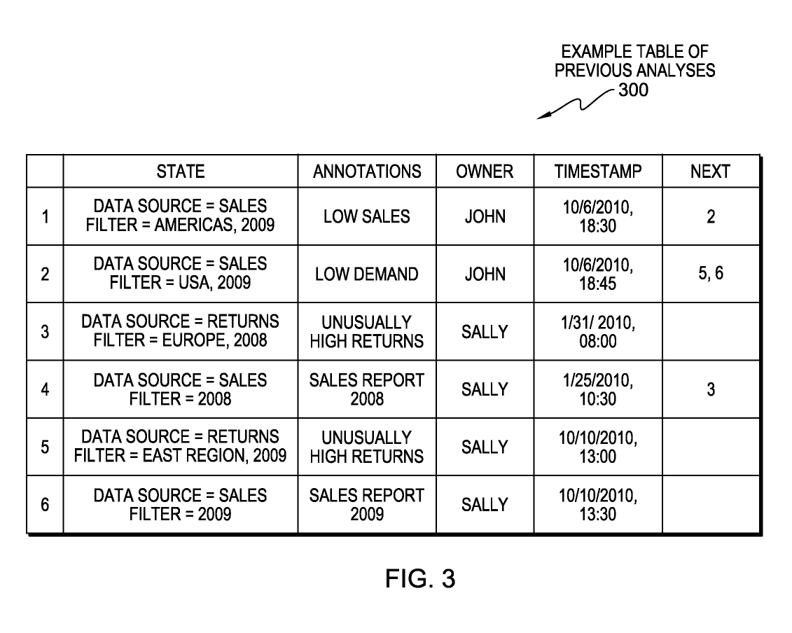

FIG. 3 illustrates exemplary data, which can be included in previous analyses 145. Example table of previous analyses 300 includes rows that correspond to six previous analyses performed by application 116 on, for example, data in business data 144, columns of state data (i.e., parameters of a data analysis step), annotations associated with an analysis, owner (i.e., individual that requested the analysis), timestamp (i.e., date and time the analysis was performed), and a next analytical step(s) (i.e., subsequent step(s) in data analysis). In example table of previous analyses 300, the state column includes parameters of the analysis step, which can be utilized to recreate that data analysis step. For example, application 116 can recreate the analysis in row 1 by applying a data source of sales, and filters of Americas and 2009. In preferred embodiments, each previous analysis of previous analyses 145 includes at least data corresponding to a state, annotations, owner, timestamp, next step(s), or other attributes associated with data analysis. If a previous analysis does not include data associated with a certain attribute, then the entry indicates that no data is associated with the attribute. For example, if a previous analysis does not have any annotations, then the previous analysis entry in previous analyses 145 will include data indicating that no annotations are present.

In example table of previous analyses 300, the “next” column includes entries that correspond to the next analysis step(s), which occurred after that data analysis step. For example, the next column of Row 1 includes “2”, which indicates that after the Row 1 analysis was requested by owner “John,” the data analysis of Row 2 was then performed, also requested by owner “John.” The process of performing the data analysis of Row 1, then the data analysis of Row 2 is an example of an analysis trail. In another example, the next column of Row 2 includes “5, 6”, which indicates that after the Row 2 analysis was requested by owner “John,” the data analyses of Rows 5 and 6 were then performed, requested by owner “Sally” as continuations of the Row 2 analysis requested by owner “John.” In this example, owner “Sally” requested to continue the Row 2 data analysis of owner “John,” and then owner “Sally” subsequently preformed the data analyses of Rows 5 and 6. The data analyses 1, 2, 5 and 6 form a data analysis trail, which was performed through data analyses requested by owners “John” and “Sally.”

Indexed data 146 includes data from previous analyses 145 that has been formatted utilizing indexing software (e.g., search engine indexing software, or other types of software capable of extracting and indexing textual data). For example, data in example table of previous analyses 300 may be indexed into attributes of: Data Source={Sales, Returns . . . }, Region={Americas, USA, Europe, East Region . . . }, Time={2008, 2009 . . . }, Annotations={Sales Report, Low Sales, Demand, Returns . . . }, Owner={John, Sally . . . }, and Timestamp={1/2010, 10/2010 . . . }. Indexed data 146 includes all data corresponding to attributes of previous analyses 145 entries. In one embodiment, the indexing software determines the attributes (e.g., Data Source, Filter, Region, etc.) utilized to determine indexed data 146. In another embodiment, application 116 receives input through user interface 114 to provide and customize the attributes utilized to determine indexed data 146. In exemplary embodiments, entries in previous analyses 145 are indexed corresponding to preferences that an application 116 provides (e.g., chronologically, etc.).

Enumerated indexed data 147 includes indexed data 146 that has been enumerated with corresponding coordinates for the basis of representation in a multidimensional space. In one embodiment, each attribute (e.g., Data Source, Region, Time, etc.) represents a dimension in a multidimensional space. Enumerated indexed data 147 is utilized to determine enumerated previous analyses 148 from previous analyses 145. In the previously discussed example with regard to example table of previous analyses 300, indexed data 146 of the six entries of previous analyses 145 is enumerated and utilized to determine enumerated indexed data 147. In this example, attributes in indexed data 146 are enumerated so that each value within an attribute has a unique numeric value that can be mapped in a multidimensional space. In an exemplary embodiment, enumerated indexed data 147 corresponding to indexed data 146 includes Data Source={1, 2} (from Data Source={Sales, Returns}), Region={1, 2, 3, 4} (from Region={Americas, USA, Europe, East Region}), and further includes each attribute of indexed data 146 converted to enumerated indexed data 147.

Enumerated previous analyses 148 includes previous analyses 145 that have been enumerated with corresponding coordinates for the basis of representation in a multidimensional space utilizing enumerated indexed data 147. Previous analyses 145 are compared to enumerated indexed data 147 to determine data points corresponding to data in previous analyses 145. In the previously discussed example with regard to example table of previous analyses 300, the six previous analyses of previous analyses 145 (each row) are enumerated utilizing enumerated indexed data 147 to determined enumerated previous analyses 148. Previous analyses 145 are enumerated corresponding to how data in a previous analysis corresponds to a set of attributes from enumerated indexed data 147. In this example, previous analyses 145 are enumerated according to “{Data Source, Filter, Annotations, Owner, Timestamp}”. In other embodiments, previous analyses 145 can be enumerated according to different attributes, and a different order of attributes. With regard to row 1 of example table of previous analyses 300, the previous analysis is enumerated as Row 1={1, (1, 2), 2, 1, 2}, wherein each ordinal element is a data point representing an element from the corresponding attribute set. With regard to row 2 example table of previous analyses 300, the previous analysis is enumerated as Row 2={1, (2, 2), 3, 1, 2}. Each previous analysis of previous analyses 145 is enumerated in order to determine enumerated previous analyses 148 (e.g., Row 3={2, (3, 1), 4, 2, 1}, Row 4={1, (0, 1), 1, 2, 1}, Row 5={2, (4, 2), 4, 2, 2}, Row 6={1, (0, 2), 1, 2, 2}).

FIG. 2 is a flowchart depicting operational steps of recommendation program 200 in accordance with an exemplary embodiment of the present invention. In one embodiment, recommendation program 200 is initiated by application 116 performing a data analysis, or responsive to an action in a data analysis. For example, recommendation program 200 initiates responsive to application 116 requesting an analysis of business data 144, and responsive to application 116 specifying new analysis parameters while analyzing business data 144.

In step 202, recommendation program 200 identifies a current data analysis step. In one embodiment, recommendation program 200 identifies the data analysis step (i.e., analysis state) that application 116 is currently performing, then recommendation program 200 enumerates the identified analysis step. Application 116 performs data analysis on business data 144 of server 140. The current data analysis step of application 116 can be represented in a text format (e.g., rows of example table of previous analyses 300). For example, the current data analysis step is a graphical depiction responsive to parameters defined through input to application 116 via user interface 114. In an example, application 116 is analyzing business data 144 on server 140. In this example, application 116 analyzes data corresponding to returns data in Europe from 2009. Recommendation program 200 identifies a current data analysis step of application 116 to be {Data Source=Returns, Filter=(Europe, 2009), Owner=Sally, Timestamp=12/2010}.

In another embodiment, recommendation program 200 enumerates the identified current data analysis step utilizing indexed data 146 and enumerated indexed data 147. In the previously discussed example with regard to application 116, analyzing data corresponding to Returns data in Europe from 2009, recommendation program 200 enumerates the identified current data analysis step (i.e., {Data Source=Returns, Filter=(Europe, 2009), Owner=Sally, Timestamp=12/2010}). Recommendation program 200 utilizes enumerated indexed data 147 (corresponding to the previously discussed example table of previous analyses 300) to determine an enumerated current data analysis step of {2, (3, 2), ( ), 2, 3}. In this example, since no annotations are included in the identified current data analysis step, recommendation program 200 has an empty value in the corresponding place in the enumerated current data analysis step.

In step 204, recommendation program 200 identifies data points corresponding to the identified current data analysis step and previous analyses. In one embodiment, recommendation program 200 identifies data points included in the enumerated current data analysis step (identified in step 202), and enumerated previous analyses 148. In exemplary embodiments, recommendation program can utilize an identification of a subset of enumerated previous analyses 148, or utilize all enumerated previous analyses 148. Enumerated previous analyses 148 and the enumerated current data analysis step are comprised of data points (i.e., the enumerated elements corresponding to each attribute). In another embodiment, recommendation program 200 determines enumerated previous analyses 148 from previous analyses 145 (as previously discussed with regard to FIG. 1), and stores determined enumerated previous analyses 148 in storage device 142. In the previously discussed example with regard to application 116, analyzing data corresponding to returns data in Europe from 2009, recommendation program 200 identifies data points in the enumerated current data analysis step (identified in step 202), and all enumerated previous analyses 148 included in storage device 142. In another example, recommendation program 200 identifies a subset of enumerated previous analyses 148 included in storage device 142, which may be defined through parameters input to recommendation program 200 (e.g., previous analyses from a certain year, data source, etc.).

In step 206, recommendation program 200 determines distances between the data points corresponding to the identified current data analysis step and previous analyses. In one embodiment, recommendation program 200 determines the distance between data points (identified in step 204) included in the enumerated current data analysis step (identified in step 202), and enumerated previous analyses 148 (in storage device 142 on server 140). Recommendation program 200 utilizes a distance computing algorithm to determine distance between data points corresponding to the identified current data analysis step and previous analyses 145. Additionally, application 116 (via input through user interface 114) can assign specific weights to attributes (e.g., data source, year, etc). In an exemplary embodiment, recommendation program 200 utilizes the following equation (weighted Euclidian distance formula) to determine distance:

$$\sqrt{{\sum }_{n = 1}^{n = N} {W}_{n} * {( {X}_{n} - {Y}_{n} )}^{2}} \qquad ( 1 )$$

where Wₙ is a weight assigned to the n^{th} attribute (e.g., data source, year, etc.), Xₙ is the dimension values of the data points of the enumerated current data analysis step corresponding to the n^{th} attribute, and Yₙ is the dimension values of the data points of enumerated previous analyses 148 corresponding to the n^{th} attribute, and N is the total number of dimensions, or attributes, for the data points. Recommendation program 200 uses equation (1) to determine the distance between the data points corresponding to the identified current data analysis step and all previous analyses, or an identified subset of all previous analyses.

In the previously discussed example with regard to application 116, analyzing data corresponding to returns data in Europe from 2009, application 116 (via input through user interface 114) assigns a weight of “2” to data source (W₁=2), and a weight of “½” to annotations (W₃=½). In this example, recommendation program 200 utilizes the exemplary distance computing algorithm to determine the distance between the data points corresponding to the identified current data analysis step and previous analysis findings 148 (i.e., example table of previous analyses 300). Recommendation program 200 determines the distance between the data points corresponding to the identified current data analysis step (Current={2, (3, 2), ( ) 2, 3}) and row 1 of example table of previous analyses 300 (Row 1={1, (1, 2), 2, 1, 2}) to be:

$$d ( Current , Row 1 ) = \sqrt{2 * {( 2 - 1 )}^{2} + ( {( 3 - 1 )}^{2} + {( 2 - 2 )}^{2} ) + \frac{1}{2} {( 0 - 2 )}^{2} + {( 2 - 1 )}^{2} + {( 3 - 2 )}^{2}} = 3$$

Recommendation program 200 determines the distance between the data points corresponding to the identified current data analysis step (Current={2, (3, 2), ( ) 2, 3}) and row 2 of example table of previous analyses 300 (Row 2={1, (2, 2), 3, 1, 2}) to be:

$$d ( Current , Row 2 ) = \sqrt{2 * {( 2 - 1 )}^{2} + ( {( 3 - 2 )}^{2} + {( 2 - 2 )}^{2} ) + \frac{1}{2} {( 0 - 3 )}^{2} + {( 2 - 1 )}^{2} + {( 3 - 2 )}^{2}} = \sqrt{9.5}$$

In this example, recommendation program 200 determines that the distance between the data points corresponding to the identified current data analysis step and the previous analysis of row 1 is less than the previous analysis of row 2. Recommendation program 200 further determines the distance between the data points corresponding to the identified current data analysis step and row 3 of example table of previous analyses 300 (Row 3={2, (3, 1), 4, 2, 1}) to be \sqrt{13}, the distance between the data points corresponding to the identified current data analysis step and row 4 of example table of previous analyses 300 (Row 4={1, (0, 1), 1, 2, 1}) to be \sqrt{16.5}, the distance between the data points corresponding to the identified current data analysis step and row 5 of example table of previous analyses 300 (Row 5={2, (4, 2), 4, 2, 2}) to be \sqrt{10}, and the distance between the data points corresponding to the identified current data analysis step and row 6 of example table of previous analyses 300 (Row 6={1, (0, 2), 1, 2, 2}) to be \sqrt{12.5}. Recommendation program 200 determines the distance between each previous analysis of previous analyses 145 that is identified in step 204 (e.g., previous analyses 145, or a subset of previous analyses 145). In exemplary embodiments, an application 116 (via input through user interface 114) can specify for recommendation program 200 to utilize a different distance computing algorithm. In response to receiving an indication to utilize a specific distance computing algorithm, recommendation program 200 determines the distance between the data points corresponding to the identified current data analysis step and previous analysis findings utilizing the indicated distance computing algorithm.

In step 208, recommendation program 200 ranks the determined distances corresponding to specified criteria. In one embodiment, recommendation program 200 ranks previous analyses 145 based on respective distances to the identified current data analysis step (determined in step 206). A shorter determined distance between data points corresponding to the identified current data analysis step and a previous analysis may indicate that the previous analysis has similar characteristics to the identified current data analysis step (identified in step 202), and a higher distance may indicate a smaller relation of characteristics. Recommendation program 200 ranks previous analyses 145 corresponding to preferences (e.g., application 116 defining a ranking algorithm) that application 116 can provide. For example, a default ranking algorithm ranks all previous analyses 145 in ascending order of distance (determined in step 206) to the identified current data analysis step (identified in step 202) from closest to furthest. With regard to the previously discussed example with regard to application 116 analyzing data corresponding to returns data in Europe from 2009, recommendation program 200 ranks previous analyses 145 of example table of previous analyses 300 in ascending order (Row 1, Row 2, Row 5, Row 6, Row 3, and Row 4). In other embodiments, application 116 (via input through user interface 114) can specify other ranking preferences that take into consideration other factors. For example, if application 116 specifies a preference for results from a certain time period, then the ranking preference algorithm determines a ranking of a subset of previous analyses 145 that correspond to the specified time period (e.g., a certain year, a certain month, etc.).

In step 210, recommendation program 200 determines recommendations. In one embodiment, recommendation program 200 determines recommendations corresponding to the top ranking previous analyses 145 (determined in step 208), and provides the determined recommendations to application 116. The determined recommendations include next data analysis steps associated with previous analyses 145. The next data analysis steps are the next analytical step(s) that are performed by application 116 after a step in a previous data analysis (e.g., the “next” column in example table of previous analyses 300). With regard to the previously discussed example with regard to application 116 analyzing data corresponding to returns data in Europe from 2009, recommendation program 200 determines the top two ranking previous analyses in example table of previous analyses 300 to be Row 1 and Row 2 (in step 208). In this example, recommendation program 200 determines recommendations of a next analytical step of Row 2 (corresponding to the next column of Row 1), and Rows 5 and 6 (corresponding to the next column of Row 2). Application 116 (via input through user interface 114) can select a recommended analysis step to continue data analysis. Recommendation program 200 can provide recommendations that correspond to one or more previous analyses 145 that have distances determined in step 208. In exemplary embodiments, the determined recommendations provide application 116 recommendations of potential next analytical steps corresponding to the current data analysis step. For example, the determined recommendations are closely related to the current data analysis step, and can provide useful and relevant information in a data analysis. In another embodiment, recommendation program 200 determines an amount of recommendations, which application 116 can specify (e.g., top ten, top 5%, etc.).

In another embodiment, recommendation program 200 provides the determined recommendations application 116, and application 116 indicates a selection of a provided determined next analytical step recommendation via input through user interface 114. Responsive to the selection of a provided determined next analytical step recommendation, recommendation program 200 records the selection of the next analytical step (e.g., in storage device 142) associated with the corresponding previous analysis of previous analyses 145. In the previously discussed example, recommendations of a next analytical step of Row 2 (corresponding to the next column of Row 1), and Rows 5 and 6 (corresponding to the next column of Row 2). Responsive to application 116 indicating a selection of Row 2, recommendation program 200 records an indication of the selection of Row 2 in storage device 142 associated with the previous analysis corresponding to row 2 in previous analyses 145. In this embodiment when ranking previous analyses 145 (step 208), recommendation program 200 can take into consideration that some previous analyses 145 have previously been provided as recommendations and then selected. Recommendation program 200 can provide an improved ranking or an indication for previous analyses 145 that have previously been provided as recommendations and then selected (e.g., determining an improved ranking for a previous analysis, displaying an indication that a previous analysis has been previously selected, etc.)

FIG. 3 depicts example table of previous analyses 300 in accordance with an exemplary embodiment of the present invention. In one embodiment, example table of previous analyses 300 includes six exemplary rows of previous analyses 145. Example table of previous analyses 300 includes rows that correspond to six previous analyses of previous analyses 145, columns of state data (i.e., parameters of a data analysis step), annotations associated with an analysis, owner (i.e. individual that performed the analysis), timestamp (i.e. date and time the analysis was performed) and a next analytical step(s) (i.e. subsequent step(s) in data analysis.

FIG. 4 depicts a block diagram of components of computer 400, which is representative of client devices 110 and 120, and server 140 in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Computer 400 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 414 and cache memory 416. In general, memory 406 can include any suitable volatile or non-volatile computer-readable storage media. Software and data 422 are stored in persistent storage 408 for access and/or execution by processors 404 via one or more memories of memory 406. With respect to client devices 110 and 120, software and data 422 represents system software 112 and application 116. With respect to server 140, software and data 422 represents recommendation program 200, business data 144, previous analyses 145, indexed data 146, enumerated indexed data 147, and enumerated previous analyses 148.

In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 410, in these examples, provides for communications with other data processing systems or devices. In these examples, communications unit 410 includes one or more network interface cards. Communications unit 410 may provide communications through the use of either or both physical and wireless communications links. Software and data 422 may be downloaded to persistent storage 408 through communications unit 410.

I/O interface(s) 412 allows for input and output of data with other devices that may be connected to computer 400. For example, I/O interface 412 may provide a connection to external devices 418 such as a keyboard, keypad, a touch screen, and/or some other suitable input device. External devices 418 can also include portable computer-readable storage media such as, for example, thumb drives, portable optical or magnetic disks, and memory cards. Software and data 422 can be stored on such portable computer-readable storage media and can be loaded onto persistent storage 408 via I/O interface(s) 412. I/O interface(s) 412 also can connect to a display 420.

Display 420 provides a mechanism to display data to a user and may be, for example, a computer monitor. Display 420 can also function as a touch screen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1-6. (canceled)

7. A computer program product for determining recommendations in data analysis, the computer program product comprising:
one or more computer-readable storage media and program instructions stored on the one or more computer-readable storage media, the program instructions comprising:
program instructions to identify an analysis step currently being performed in a data analysis;
program instructions to identify data points corresponding to the identified analysis step currently being performed and one or more previous analyses;
program instructions to determine a distance between the data points corresponding to the identified analysis step currently being performed and each of the one or more previous data analyses utilizing a distance computing algorithm; and
program instructions to determine a ranking of the one or more previous data analyses corresponding to the determined distances between the data points corresponding to the identified analysis step currently being performed and each of the one or more previous data analyses.

8. The computer program product of claim 7, further comprising program instructions to:
determine recommendations in the data analysis utilizing the determined ranking of the one or more previous data analyses, wherein the recommendations include possible next analytical steps that correspond to the one or more previous data analyses.

9. The computer program product of claim 7, wherein the one or more previous data analyses are stored previous steps in data analysis that include parameters corresponding to performing data analysis steps of the one or more previous data analyses.

10. The computer program product of claim 7, wherein the program instructions to identify data points corresponding to the identified analysis step currently being performed and one or more previous analyses, comprise programs instructions to:
index data included in the one or more previous analyses utilizing text indexing software, wherein the indexed data includes attributes of the one or more previous analyses and data corresponding to the attributes;
determine a numerical representation of the indexed data, wherein data of the one or more previous analyses is represented by a numerical data point; and
determine a numerical representation of data points of the identified analysis step currently being performed and one or more previous analyses.

11. The computer program product of claim 7, further comprising program instructions to:
receive an indication of a distance computing algorithm to utilize in determining distance between the data points corresponding to the identified analysis step currently being performed and each of the one or more previous data analyses,
wherein the received distance computing algorithm is an algorithm that is utilized to determine distance between data points in a multidimensional space.

12. The computer program product of claim 7, further comprising program instructions to:
receive an indication of preferences for determining the ranking of the one or more previous data analyses,
wherein the received preferences include an indication of factors to be utilized in determining the ranking of the one or more previous data analyses.

13. A computer system for determining recommendations in data analysis the computer system comprising:
one or more computer processors; and
one or more computer-readable storage media;
program instructions stored on the computer-readable storage media for execution by at least one of the one or more processors, the program instructions comprising:
program instructions to identify an analysis step currently being performed in a data analysis;
program instructions to identify data points corresponding to the identified analysis step currently being performed and one or more previous analyses;
program instructions to determine a distance between the data points corresponding to the identified analysis step currently being performed and each of the one or more previous data analyses utilizing a distance computing algorithm; and
program instructions to determine a ranking of the one or more previous data analyses corresponding to the determined distances between the data points corresponding to the identified analysis step currently being performed and each of the one or more previous data analyses.

14. The computer system of claim 13, further comprising program instructions to:
determine recommendations in the data analysis utilizing the determined ranking of the one or more previous data analyses, wherein the recommendations include possible next analytical steps that correspond to the one or more previous data analyses.

15. The computer system of claim 13, wherein the one or more previous data analyses are stored previous steps in data analysis that include parameters corresponding to performing data analysis steps of the one or more previous data analyses.

16. The computer system of claim 13, wherein the program instructions to identify data points corresponding to the identified analysis step currently being performed and one or more previous analyses, comprise programs instructions to:
index data included in the one or more previous analyses utilizing text indexing software, wherein the indexed data includes attributes of the one or more previous analyses and data corresponding to the attributes;
determine a numerical representation of the indexed data, wherein data of the one or more previous analyses is represented by a numerical data point; and
determine a numerical representation of data points of the identified analysis step currently being performed and one or more previous analyses.

17. The computer system of claim 13, further comprising program instructions to:
receive an indication of a distance computing algorithm to utilize in determining distance between the data points corresponding to the identified analysis step currently being performed and each of the one or more previous data analyses,
wherein the received distance computing algorithm is an algorithm that is utilized to determine distance between data points in a multidimensional space.

18. The computer system of claim 13, further comprising program instructions to:
receive an indication of preferences for determining the ranking of the one or more previous data analyses,
wherein the received preferences include an indication of factors to be utilized in determining the ranking of the one or more previous data analyses.
